(19) United States
(12) Patent Application Publication
(10) Pub. No.: US 2019/0333346 A1
(43) Pub. Date: Oct. 31, 2019

(54) ELECTRONIC SIGNING TABLET

(71) Applicant: MAIN CONTINENTAL TECHNOLOGY LIMITED, Hong Kong (CN)

(72) Inventors: WING KIN MARTIN HUI, HONG KONG (CN); FONG MAN EMILY HUI, HONG KONG (CN)

(21) Appl. No.: 16/375,419

(22) Filed: Apr. 4, 2019

(30) Foreign Application Priority Data
Apr. 30, 2018 (AU) 2018202984

(51) Int. Cl. G07G 1/00; G07G 1/12; G06K 9/00

(52) U.S. Cl. CPC G07G 1/0018; G07G 1/12; G06K 9/00087; G06K 9/00161; G06K 9/00617

(57) ABSTRACT

An electronic signing tablet 100 for capturing the signature of a customer making payment by credit card is disclosed. The tablet integrates the display of payment details and the surface for capturing customer's signature. The tablet is pivoted to a support 105 which prevents the tablet from being passed around and dropped, and the pivot allows the table to be flipped over to the customer from the cashier to facilitate capturing of the customer's writing.

### FIELD OF INVENTION

This invention relates to point-of-sale electronic equipment. In particular, this invention relates to electronic signature pads.

### BACKGROUND OF THE INVENTION

The point of sale (POS) system is a device provided at the time and place where a retail transaction is completed, by which a customer makes a payment to the merchant. Typically, the merchant would prepare an invoice for the customer, which may be a cash register printout. If the customer is paying by credit card, the customer is typically required to sign on a signature slip. Signed signature slips are kept for verification purposes in the event of dispute over whether a purchase was transacted properly or rightfully.

It has been proposed to provide electronic signature capture and storage, in order to save on time and paper. Instead of a slip of paper, the customer signs on a touch sensitive pad which captures his signature electronically and stores it. However, the touch sensitive pad is usually linked to the cashier system by a cable. In a mess of cables, the customer is usually unaware whether the touch sensitive pad is linked to the cashier system right before him or to another cashier system. The payment amount in a display on the cashier system which the customer sees may not be the amount he is signing off.

Accordingly, it is desirable to provide device to improve security and accuracy of such electronic signing off systems.

### SUMMARY OF THE INVENTION

The invention proposes an electronic signing tablet comprising a housing, a touch sensitive surface set into the housing, the housing pivoted onto a support such that the housing can be flipped over about the pivot.

Preferably, the housing can be flipped about a horizontal axis. Flipping over a horizontal axis saves space about the housing which would be required if the housing is slipped vertically.

Typically, the touch sensitive surface is configured to capture manuscript signature of a person.

Typically, the tablet further comprises a screen for displaying purchase information. Preferably, however, the surface of the screen is the touch sensitive surface, although in some embodiments the screen and the touch sensitive surface can be separate items provided into the same housing. Having a screen for displaying purchase information placed together or adjacent the touch sensitive surface for capturing manuscript signature provides an advantage that the customer can see exactly the payment amount he is signing off.

Providing the tablet onto a fixed support provides that a cashier and a customer may both use the same tablet without fear of dropping and damaging the tablet, which may happen if the tablet is not fixed on a support and may be handed from cashier to the customer.

Preferably, at least one movement restriction device is provided for determining the extent to which the housing can be flipped on the support. This allows a slant to be provided to the tablet, which allows the customer to read the screen and to sign on the touch sensitive surface easily.

Preferably, the tablet further comprises a gyrometer for sensing angular displacement of the screen. This provides the possibility that, the display information to be inverted upright automatically if the tablet is flipped over the horizontal axis.

Preferably, the tablet further comprises a camera for capturing a photograph of a person giving his identity via the electronic identification obtaining tablet. This provides a deterrent effect against use of stolen credit cards, as the customer's picture can be captured and stored for verification.

Optionally, a camera is provided to capture the fingerprint or the iris of a person. Advantageously, this allows biometric verification.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 shows an embodiment of the invention;

FIG. 2 is the embodiment of FIG. 1 shown in a different position;

FIG. 3 shows another embodiment to that of FIG. 1;

FIG. 4 shows a simplified version of the embodiment of FIG. 1;

FIG. 5 is the embodiment of FIG. 4 shown in a different position:

FIG. 6 shows yet another embodiment to that of FIG. 1;

FIG. 7 shows yet another embodiment to that of FIG. 1;

FIG. 8 shows yet, another embodiment to that of FIG. 1;

FIG. 9 is the embodiment of FIG. 8 shown in a different position;

FIG. 10 shows yet another embodiment to that of FIG. 1; and

FIG. 11 is the embodiment of FIG. 10 shown in a different position.

### DETAILED DESCRIPTION OF THE INVENTION

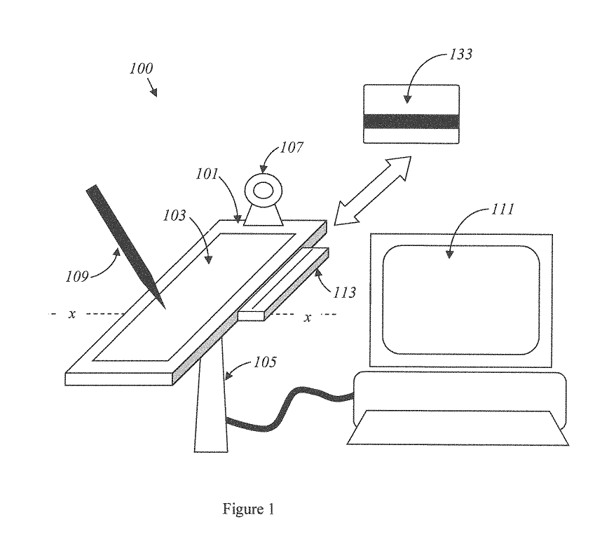

FIG. 1 shows an electronic signing tablet 100 comprising a housing 101. The housing is generally planar in shape and serves as a supporting board on which a person may write. A touch sensitive surface 103 is set into the housing.

The touch sensitive surface 103 can be written upon, and suitable processing modules within the tablet picks up the writing and digitise the writing immediately, FIG. 1 illustrates a stylus 109 that can be used to write on the touch sensitive surface tablet. The technology for a touch sensitive surface may be based on capacitive sensing, heat sensing and so on, which is not the specific concern of this description and elaboration thereof is not required.

The tablet can be used to capture the signature of a person at the point of sale (POS) who is paying by credit card, send and store the signature for verification if needed. There is no need for pieces of papers to be manually matched for customer signatures when the accounts for sales are checked. An image of the writing is created progressively as the same time as the stylus is writing on the touch sensitive surface 103, in order to mimic the writing of a pen on a piece of paper.

The touch sensitive surface either is also a screen for displaying purchase information or is superimposed with such a screen. The cashier who prepares the billing invoice enters the price of purchase into a cashier machine 111, or a computer configured into a cashier machine, and the billing details will be shown on the tablet. In this case, the customer knows exactly the amount and the purchase he is signing off on his credit account.

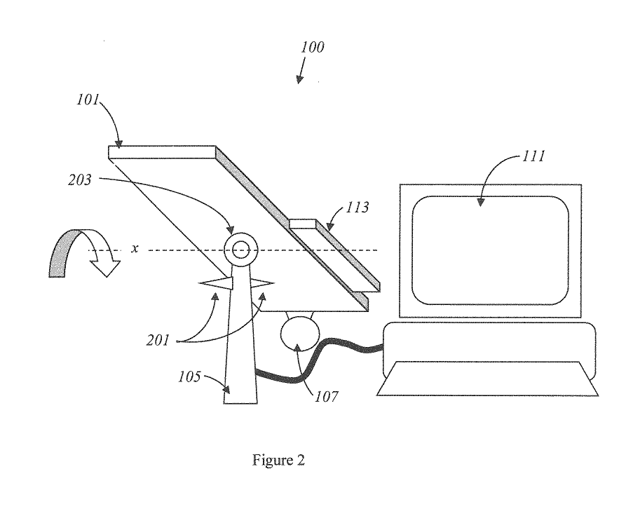

The external surface of the base of the housing is pivoted onto a support 105 in such a manner that the housing can be flipped on the support about the pivot. The base of the housing and the pivot is visible in FIG. 2. FIG. 2 shows the tablet in the same direction as FIG. 1. The tablet has been flipped over the pivot about an axis x illustrated in broken line.

Preferably, the tablet contains a device for detecting the orientation or position of the tablet. This device can be a gyrometer for sensing angular displacement. When the tablet is pivoted such that it faces the cashier, the image shown in the screen will be upright for the cashier so that the cashier can read the billing details displayed in the screen. When the tablet is flipped over, about the support, the image is inversed so that it is again upright and the customer can read the billing details.

Preferably, at least one movement restriction device 203 is provided for determining the extent to which the housing can be flipped. This can be a mechanical stop 201 which is positioned on the support, which stops the tablet from being flipped over completely on either side of the pivot. FIG. 2 shows two stops on the support, one for preventing the tablet from being positioned vertically on the side of the customer and the other for preventing the tablet for being positioned vertically on the side of the cashier. Each stop allows the tablet to be angled to the horizontal in such a way that a person is able to read the screen display. A slanted tablet allows the customer to sign on the screen in an ergonomic way. In contrast, a fully flipped over screen which is hung vertically is more difficult to sign on and, has to be positioned at the eye level of the reader in order for him to read the screen display.

A magnetic strip reader 113 is also attached to the side of the housing. When the screen is slipped into the view of the customer, the customer may swipe the credit card 133 of the customer to read the credit account details. This allows the customer to know that his card has been swiped into the system for the purchase displayed on the screen, preventing any misappropriation of his credit card on a different purchase by the sales person. As the tablet is manufactured by a third party who has no interest in misappropriating sales, the sales person and the customer are both secured in making the transaction using the tablet.

A camera 107 is provided on one side of the housing for capturing the image of the customer as he signs on the tablet. The camera is positioned such that it is at the top of the tablet when the tablet is flipped into the position facing the customer. If the camera is placed at the bottom or on one side of the tablet, the hand signing on the tablet may block the view of the camera. The camera provides added security. The customer who is making payment via credit card and signing on the tablet will be encouraged to use his own credit card since his picture will be captured. This is a deterrent against use of stolen credit cards.

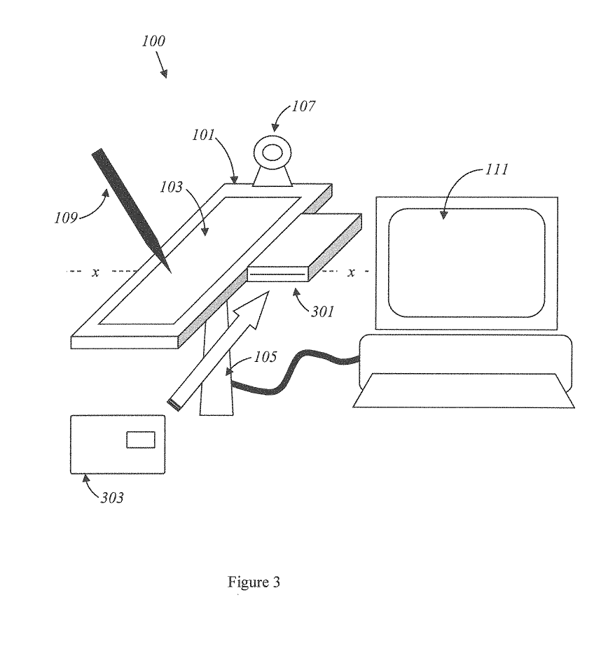

FIG. 3 shows another embodiment in which the magnetic strip reader 113 is replaced by a chip reader 301 for reading the chip on a credit card. The mouth of the chip reader is facing the customer when the screen is flipped into his view so that the customer may insert his credit card 303 into the tablet. Although not shown, an embodiment which comprises both a magnetic strip reader and a chip reader is within the contemplation of the invention. Furthermore, other methods of reading a credit card may be used instead, such as a radio frequency identification system (RFID) or a near field communication system (NFC).

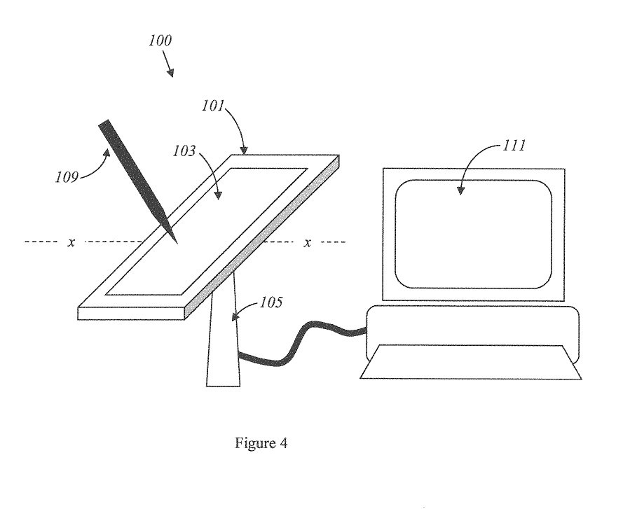

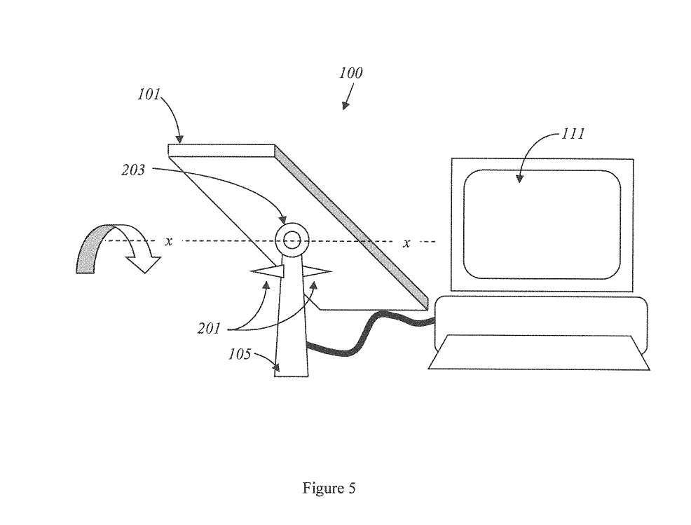

However, a simpler embodiment as shown in FIG. 4 without any chip reader or magnetic strip reader, and without any camera is also within the contemplation. The screen simply displays details of the purchase, after the cashier takes credit card details using conventional credit card facilities. FIG. 5 shows the simpler embodiment of FIG. 4 slipped into view for the cashier, away from the view of the customer.

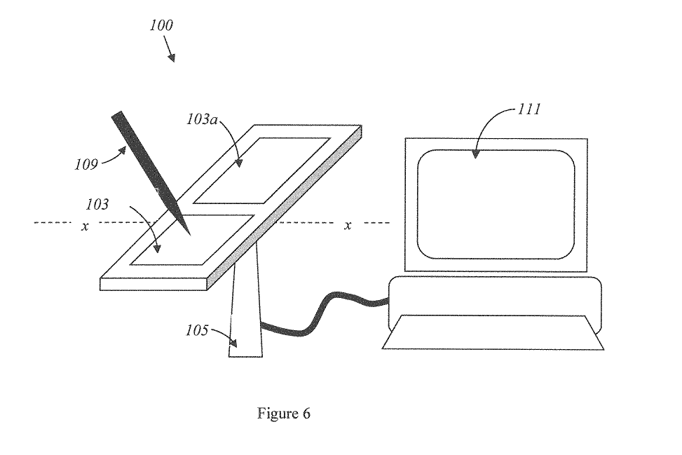

FIG. 6 shows a variation of the embodiments. The camera and magnetic strip reader are omitted for simplicity in FIG. 6. FIG. 6 shows the screen and the touch sensitive surface to be placed separately into the housing of the tablet. When the tablet is flipped over into the view of the customer, the display screen 103a is at the top of the tablet and the touch sensitive surface 103 is at the bottom.

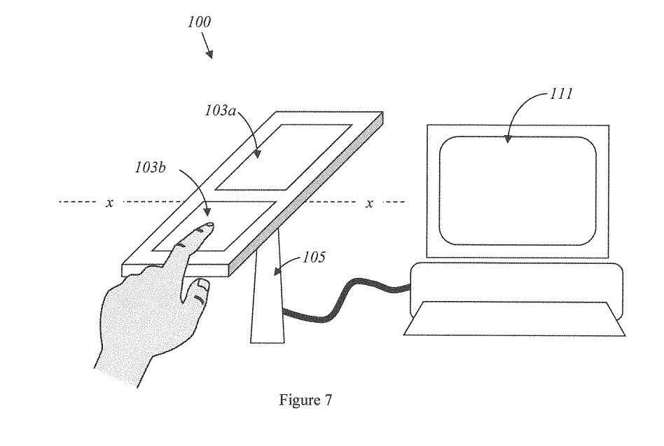

FIG. 7 shows yet a further variation of the embodiment in which the touch sensitive surface 103b is replaced by, or is included with, a camera for reading the fingerprint of the customer in order that biometrics verification may be used.

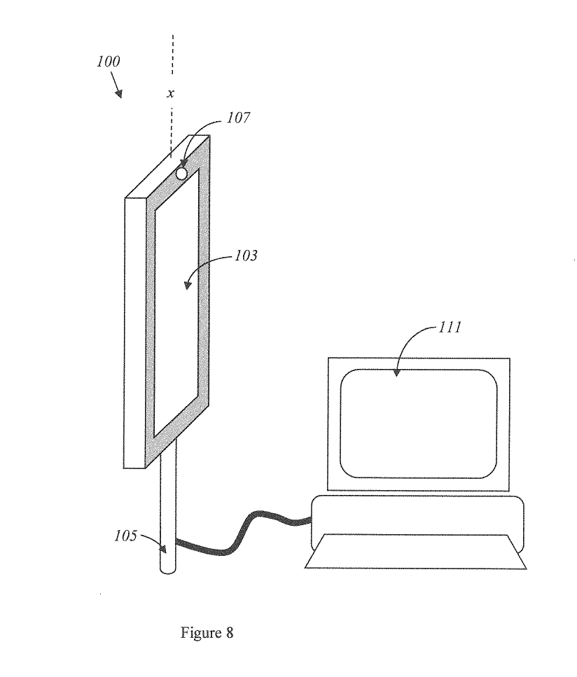

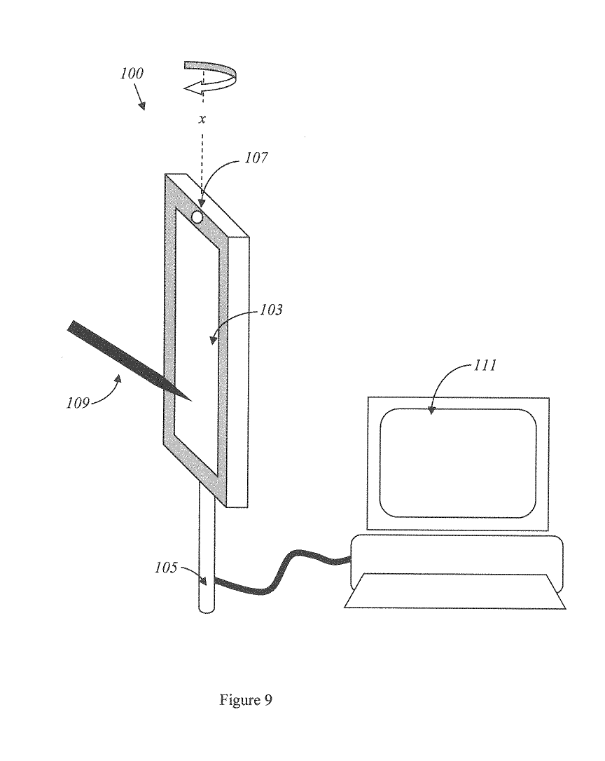

FIG. 8 shows another embodiment in which the tablet is provided upright on a support and which is able to rotate about a vertical axis. The cashier flips the tablet by rotating it vertically into the customer's view. Although this embodiment is less ergonomic for the purpose of signing on the touch sensitive screen, this embodiment allows a camera at the top of the frame to capture iris image for biometric identification. FIG. 9 illustrates how table is rotated about a vertical axis into the customer's view for him to sign on the touch sensitive screen with a stylus.

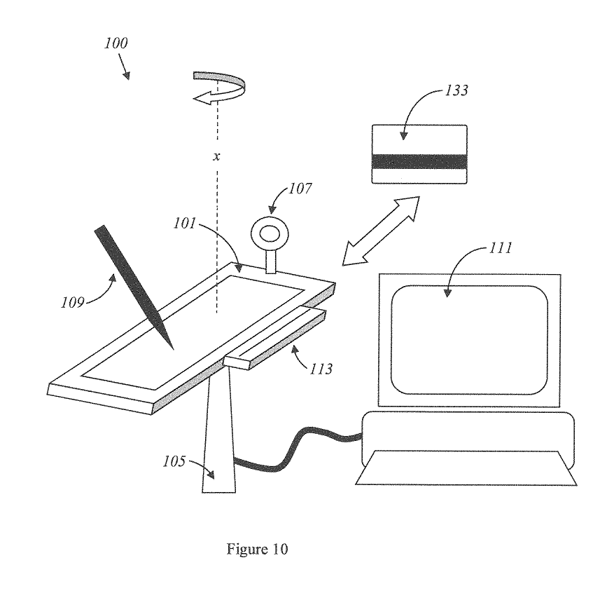

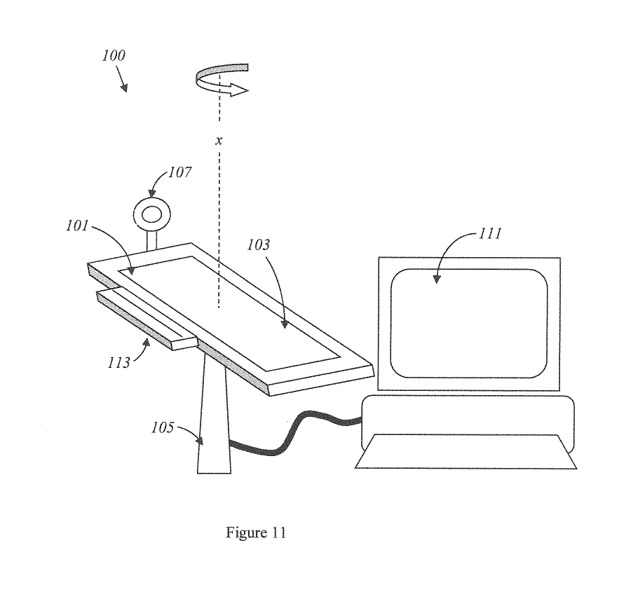

FIG. 10 shows another embodiment in which the tablet is fixed in a slanted angle on the support and cannot be flipped over about a horizontal axis. Instead, the tablet can be rotated about a vertical axis aligned to the support. The tablet can be rotated into the view of the customer or the cashier, as illustrated in FIG. 11. This embodiment does not require the image on the screen to be inverted whenever it is flipped into the view of the other person, whether the person is the customer or the cashier. However, the embodiment of FIG. 1 is preferred over that of FIG. 10 as a horizontally swivelling tablet requires space around it in which it can move.

The embodiments provide a fixed point for transaction verification, which is advantageous over wireless, portable point of sales systems. The wireless, portable versions are prone to be damaged by the customer if he drops them.

While there has been described in the foregoing description preferred embodiments of the present invention, it will be understood by those skilled in the technology concerned that many variations or modifications in details of design, construction or operation may be made without departing from the scope of the present invention as claimed.

1. An electronic signing tablet comprising:
a housing;
a touch sensitive surface set into the housing;
the housing pivoted onto a support such that the housing can be flipped over about pivot; and
at least one movement restriction device for determining the extent to which the housing can be flipped.

2. An electronic signing tablet as claimed in claim 1, wherein
the housing can be flipped about a horizontal axis.

3. An electronic signing tablet as claimed in claim 2, further comprising:
a gyrometer for sensing angular displacement of the screen.

4. An electronic signing tablet as claimed in claim 1, further comprising:
a screen for displaying purchase information.

5. An electronic signing tablet as claimed in claim 1, wherein the touch sensitive surface is configured to capture a manuscript signature of a person.

6. An electronic signing tablet as claimed in claim 1, farther comprising:
a camera configured to capture the fingerprint of a person.

7. An electronic signing tablet as claimed in claim 1, further comprising:
a camera configured to capture an image of the iris of a person.

8. An electronic signing tablet as claimed in claim 1, further comprising:
a camera for capturing a photograph of a person giving his identify via the electronic identification obtaining tablet.
